(19) United States
(12) Patent Application Publication
(10) Pub. No.: US 2007/0245612 A1
(43) Pub. Date: Oct. 25, 2007

(54) Medical alert device

(76) Inventor: Eugene Lee Tresenfeld, Eugene, OR (US)

Correspondence Address: RISTO A. RINNE, JR.;COMPLETE PATENTING SERVICES, 2173 EAST FRANCISCO BOULEVARD, SUITE E, SAN RAFAEL, CA, 94901, US

(21) Appl. No.: 11/298,843

(22) Filed: Dec. 8, 2005

(51) Int. Cl. G09F 3/14; G08B 23/00

(52) U.S. Cl. 40/665; 340/573.1

(57) ABSTRACT

An apparatus for preventing impact to a person with an injury or infirmity includes a member that is worn over a portion of the body. Straps or other methods are used to secure the member where desired. The member provides a level of impact protection. The member can include optional cushioning material and a visible warning or audible warning, or both. The warning can be a written message or a well-recognized symbol, for example, a Red-Cross symbol. The written message or symbol or other portion of the apparatus can be illuminated, if desired. The illumination and audible warning can be constant or they can pulse on and off. A proximity sensor detects the approach of others and activates the visible and audible warnings. If desired, a command can then be spoken such as, “Stop! Do not approach!”

### BACKGROUND OF THE INVENTION

1. Field of the Invention

The present invention, in general relates to warning indicators and, more particularly, to a device for warning others that a person has a medical infirmity or medical condition which can be adversely affected by impact.

People who are ill or recovering from injury are especially vulnerable to impact, jarring, being startled, or surprised. They can easily fall and if an injured area is impacted, additional damage can occur.

Sometimes the need to warn is global, for example, if a person is weak from surgery, chemotherapy, or the like. In these instances, others need to be generally careful when approaching such a person, but there is no specific area that is injured.

Sometimes the need to warn is more specific, for example, if a person is recovering from a broken arm, the person would not want others to bump into that particular arm. Any impact to that arm would likely result in an increased risk of re-fracturing it. An impact would also likely be especially painful.

Pain is not an insignificant concern. If a person feels great pain, they may react with a sudden movement that, by itself, could cause injury. For example, a sudden reaction to pain could cause the already injured person to bump into an object, possibly inflicting further injury. The sudden movement in reaction to the pain could cause a loss of balance and might result in a fall, again raising the possibility of inflicting yet further injury.

There is a need to warn others that a person has a medical condition and should not be bumped, jarred, impacted, surprised, startled, etc. There is also a need to warn people that specific areas of the person's body are especially vulnerable to impact.

There is a further need to warn others to keep a reasonable distance away from an injured or otherwise vulnerable person. For example, a person may have a balance disorder and may require a larger surface area to safely navigate. Or they may use a “walker” and not want anyone to approach too close and bump the walker (appliance).

And sometimes, it is not possible to ward off all potential impacts. It is desirable to provide an energy absorbing layer that can protect an injured area from impact by others.

Accordingly, there exists today a need for a medical alert device.

Clearly, such an apparatus would be a useful and desirable device.

2. Description of Prior Art

Warning signs are, in general, known. For example, the use of a medical alert bracelet to warn paramedics of a medical condition requiring special treatment, for example, diabetes, is known. However, devices to warn others not to approach too close, surprise, or impact another person is believed to be new. While the structural arrangements of the above described devices may, at first appearance, have similarities with the present invention, they differ in material respects. These differences, which will be described in more detail hereinafter, are essential for the effective use of the invention and which admit of the advantages that are not available with the prior devices.

### OBJECTS AND SUMMARY OF THE INVENTION

It is an object of the present invention to provide a medical alert device that provides a visible warning to others not to contact, impact, startle, or approach too close to a wearer of the device.

It is also an important object of the invention to provide a medical alert device that provides an audible warning to others not to contact, impact, startle, or approach too close to a wearer of the device.

Another object of the invention is to provide a medical alert device that provides both a visible and an audible warning to others not to contact, impact, startle, or approach too close to a wearer of the device.

Still another object of the invention is to provide a medical alert device that is adapted to be worn proximate a specific area of a body and which is used to provide a warning to others not to contact or impact the specific area of the body of the person wearing the device.

Still yet another object of the invention is to provide a medical alert device that detects when a person approaches too close and in response to such detection, provides a warning to others not to contact, impact, startle, or approach too close to a wearer of the device.

Yet another important object of the invention is to provide a medical alert device that provides a passive warning.

Still yet another important object of the invention is to provide a medical alert device that includes a source of illumination.

A first continuing object of the invention is to provide a medical alert device that is detachably attachable and adapted to be worn over garments.

A second continuing object of the invention is to provide a medical alert device that is detachably attachable and adapted to be worn over garments or directly on the skin and which provides impact protection.

A third continuing object of the invention is to provide a medical alert device that can contribute toward increasing the peace of mind of a vulnerable wearer of the device.

A fourth continuing object of the invention is to provide a medical alert device that provides protection from impact.

A fifth continuing object of the invention is to provide a medical alert device that includes a member which provides protection from impact.

A sixth continuing object of the invention is to provide a medical alert device that includes a member which provides protection from impact and cushioning material which provides additional protection from impact.

Briefly, a medical alert device that is constructed in accordance with the principles of the present invention has a member that is worn over a portion of the body. Straps or other methods are used to secure the member where desired. The member provides a level of impact protection. The member can include optional cushioning material and a visible warning or an audible warning, or both. The warning can be a written message or a well-recognized symbol, for example, a Red-Cross symbol or a reflective material. The written message or symbol or other portion of the apparatus can be illuminated, if desired. The illumination and audible warning can be constant or they can pulse on and off or change color, if preferred. A proximity sensor detects the approach of others and activates the visible and audible warnings. If desired, a command can then be spoken such as, “Stop! Do not approach!”

### BRIEF DESCRIPTION OF THE DRAWINGS

FIG. 1 is a view in perspective of a medical alert device.

FIG. 2 is a view as shown in FIG. 1 as seen along the lines 2-2 therein.

FIG. 3 is a front elevational view of the medical alert device of FIG. 1 worn on two locations of a user.

FIG. 4 is a block-diagrammatic view of an electrical circuit of an electronic version of the medical alert device that alerts an approaching person by visual means or audible means or both to exercise caution.

FIG. 5 is a block-diagrammatic view of an electrical circuit of an electronic version of the medical alert device that detects an approaching person and then alerts the person by visual means or audible means or both to exercise caution.

### DETAILED DESCRIPTION OF THE INVENTION

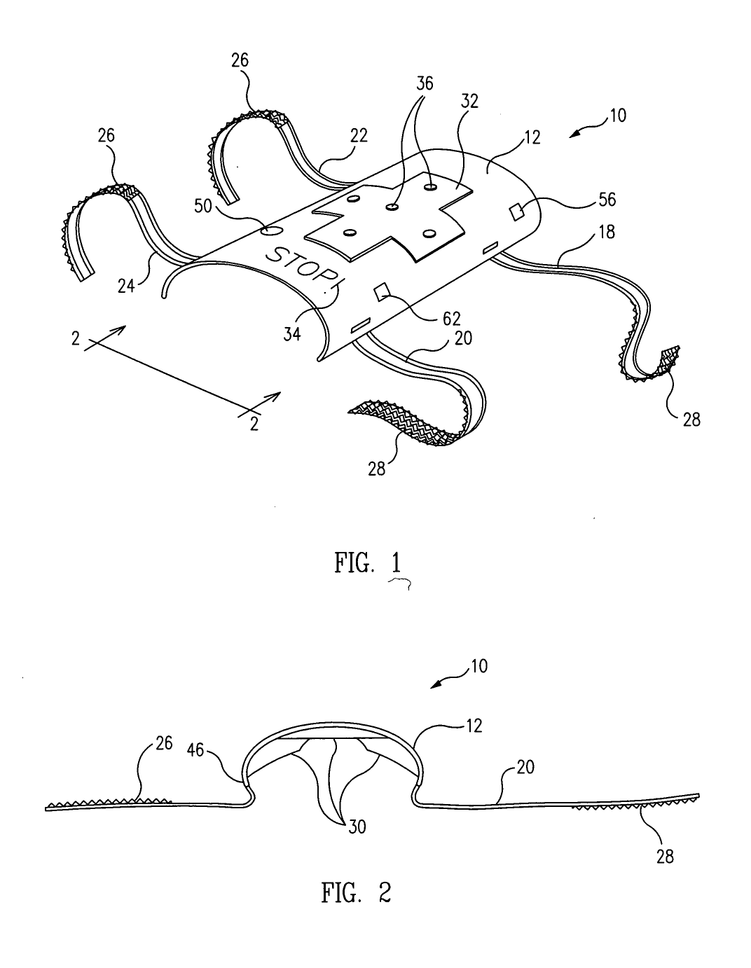

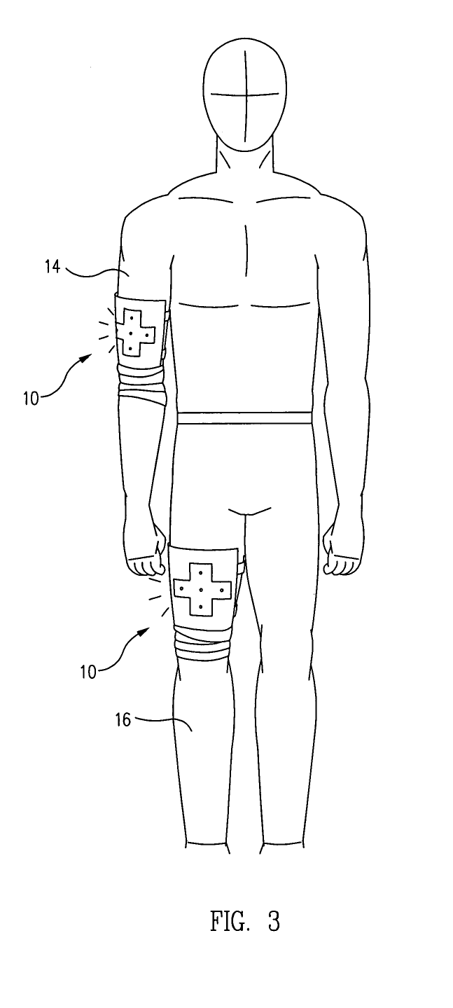

Referring on occasion to all of the drawings and now in particular to FIG. 1 and FIG. 2 is shown, a medical alert device, identified in general by the reference numeral 10.

The medical alert device 10 includes a member 12 that is worn over a portion of the body. The member 12 is formed of plastic or other material that, preferably, provides a level of impact protection.

A primary purpose of the medical alert device 10 is to warn others that an injury or infirmity exists and that caution in approaching should be exercised. In particular, the medical alert device 10 warns others not to bump, impact, or otherwise make contact with the wearer of the medical alert device 10, and especially so where the medical alert device 10 is being worn.

The member 12, as shown, is curved along a longitudinal axis thereof. This provides a shape that is ideally suited for placement around an arm 14 or a leg 16 of a user. The member 12 could, of course, be formed of a flat panel that is sufficiently flexible so that it can be curved around the arm 14 or the leg 16 during its application and use.

For different areas of the body, the medical alert device 10 will include a different shape. For example, if it is worn over a torso, it would be larger and more planar in shape. Any variation is shape and sizing is possible.

A plurality of straps 18, 20, 22, 24 are each attached at one end thereof to the member 12. The straps 18-24 include corresponding mating halves of a hook and loop fastener 26, 28 along their longitudinal lengths, and as such, are used to secure the medical alert device 10 around the arm 14 or leg 16 of the user. The hook and loop fastener 26, 28 allows the combined length of each pair of straps (18 and 22, 20 and 24) to be attached together and to include a variable combined overall length.

A cushioning material 30 is optionally provided along a portion of the medical alert device 10. The cushioning material 30 absorbs impact energy, in the event the medical alert device 10 is bumped by an inadvertent person during their approach, and therefore it provides an additional fail-safe level of protection to the wearer. The member 10 attenuates some of the impact energy and the cushioning material 30 attenuates an additional amount.

The medical alert device 10 preferably includes a symbol 32. A preferred symbol 32 that is shown is the well-known and well-recognized Red-Cross symbol that is used to signify a medical purpose.

The symbol 32 can include a new design or any preferred design or combination of designs. It also may include (either with the symbol 32 or instead of the symbol) a written message 34, such as “STOP!” or “DO NOT APPROACH”, or any other preferred message to alert others who may be approaching.

The medical alert device 10 also includes a plurality of LEDs 36 (light emitting diodes). If preferred, any other visibility enhancing or audible (or both) method of alerting others may also be included.

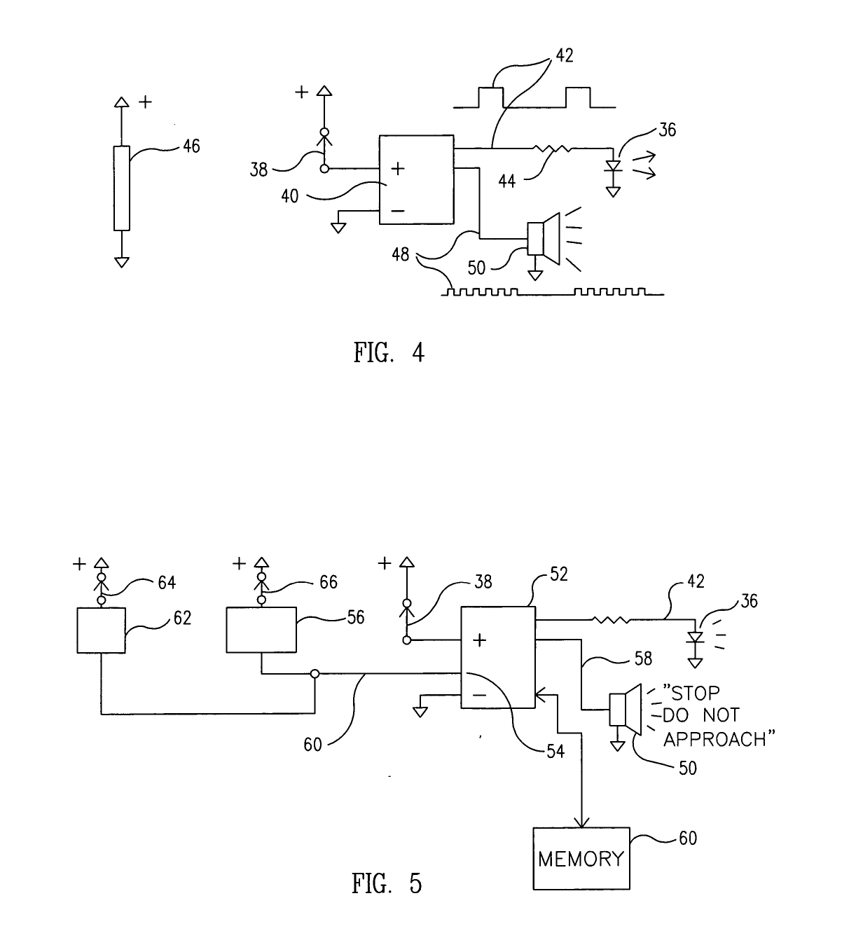

Referring to FIG. 4, a simple circuit is shown that includes an on-off switch 38, an integrated circuit timer 40 that outputs a periodic pulse output 42, a resistor 44, and the LEDs 36. The integrated circuit timer 40 can include any IC that is designed or adaptable for this purpose or it may include a microprocessor with a simple program in ROM, as is well known in the electronic and computer arts.

A small battery 46 is attached where desired and supplies electrical power to the medical alert device 10.

When the switch 38 is turned on, the LEDs 36 will flash on and off periodically. This makes the user even more noticeable. A less expensive version of the medical alert device 10 could eliminate the integrated circuit timer 40 and maintain a constant illumination, if preferred. It is also possible for certain of the LEDs 36 to be a particular color and for other of the LEDs 36 to be a different color and to pulse one color on and the other color off and then to reverse that pattern repeatedly so that the color of illumination alternates as well.

If preferred, the LEDs 36 can be arranged in such a manner as to form the letters of the written message 34, thereby making the message an illuminated message. Other types of displays (not shown) can also be included and similarly used.

If preferred, a second output 48 is provided that provides an audible and repeating periodic sign wave (or other waveform) that is output to a small speaker 50 that is attached to the medical alert device 10.

A periodic beep is heard emanating from the speaker 50 and this is useful also in alerting those that may be nearby or approaching the user.

Referring now also to FIG. 5, a modified circuit 52 includes a trigger input 54. When the trigger input 54 is activated (as is described in greater detail hereinafter), the periodic pulse output 42 and a third output 58 of the modified circuit 52 are energized. Each output 42, 58 provides a unique waveform or signal for a predetermined period of time, as is described in greater detail hereinafter.

The predetermined period of time can be set in memory or it can be a variable that the user may set. Fifteen to thirty seconds is a possible range for the predetermined period of time, however it may be shorter or longer, as desired.

If the optional modified circuit 52 is used, a sensor 56 is attached to the medical alert device 10 and it detects a person that is approaching too close. Infrared and other types of sensors 56 are well known in the security and alarm industry and are also used to turn either outside or inside lights on when a person moves within range of the sensor 56.

The sensor 56 outputs a trip signal 60 to the trigger input 54 of the modified circuit 52. The trip signal 60 informs the modified circuit 52 that someone (or a group of people) have approached and are now within the range of the sensor 56. As long as the person remains within the range of the sensor 56, it will continually output the trip signal 60 and therefore, continually activate the modified circuit 52 for as long as the potential threat remains nearby. Accordingly, the sensor 56 functions as a type of proximity sensor.

The sensor 56 is selected for each particular application. For certain serious injuries or infirmities, the sensor 56 that is used will output the trip signal 60 when a person is farther away than would the sensor 56 that is used with a less serious injury or infirmity.

When the trigger input 54 of the modified circuit 52 is activated by the trip signal 60, the modified circuit 52 will energize the outputs 42, 58 for a predetermined period of time. If desired, the outputs 42 could be the same as was described above for use with the integrated circuit time 40. According to this design embodiment, the third output 58 would be the same as the second output 48, described above.

Another option exists and that is for the third output 58 to drive the speaker 50 with an analog output (or a digital output if the speaker 50 is adapted to convert the digital output into a signal that can effectively drive the speaker 50).

The analog output of the third output 58 includes, in a memory 60 that is provided, a speech pattern. For example, the third output 58 could drive the speaker 50 so that, “Stop! Do not approach!” is heard when a person gets within the range of the sensor 56. This could be in addition to the LEDs 36 or instead of the visible indication.

Furthermore, it is possible to modulate the volume so that the volume changes in relation to the proximity of the person that is approaching. If the sensor 56 detects the person is over ten feet away, for example, a first volume “Stop! Do not approach!” message is heard. If the sensor 56 detects the person is now only about two feet away, a second volume message “Stop! Do not approach!” is heard. The second volume message could be considerably louder to convey a sense of urgency. Also, if preferred, the message content could vary as well. When the sensor 56 detects the person is only two feet away the message, possibly at a greater second volume, could be, “Stop now!” or “Approach no closer!” If desired, the color or pattern of illumination (i.e., the way the LEDs 36 are pulsed) could be set to vary in accordance with the proximity of the person that is approaching.

For most situations, when the sensor 56 detects an approach, the speaker 50 will provide an audible warning and the LED's will provide a visible warning. If the warnings are not heeded and the person wearing the medical alert device 10 is impacted by the person, then the member 12 will provide a first level of impact protection for the user.

People healing from injuries or who suffer from infirmities are afraid of being bumped, being startled, losing their balance if bumped or startled. They must divert their attention between attending to their own motive needs and watching out for careless or unaware people who may suddenly approach.

The use of the medical alert device 10, according to any of the disclosed embodiments, removes much of the burden of watching out for others from the user (the person with the injury or infirmity). The medical alert device 10 shifts much of that responsibility to the person who is approaching.

It provides a visible indication that, over time, will become well-recognized by the population in general. When the situation warrants additional precaution, the use of illuminated sources (i.e., the LEDs 36) or audible warning indications (the speaker 50) are able to provide an even greater warning capability and therefore increase both safety and peace of mind for the user.

Re-injuries will be decreased as a result. This will lessen the cost of health care and encourage people with injuries and infirmities to leave the safety of their homes and convalescent facilities and begin to integrate into public situations sooner than they otherwise would.

If desired, a second sensor 62 is also used. As many sensors 56, 62 as desired are included, each one with a field of view in a particular direction. Additional on-off switches 64, 66 are provided, one for each sensor 56, 62 when a plurality are used. If desired, a master switch is included to turn the medical alert device 10 on or off and the additional switches 64, 66 are used to modify its operation, accordingly.

This allows the user to disable detection in any particular direction. If, for example, a caregiver is walking beside the user it would be undesirable to keep listening to the device 10 warn the caregiver to “Stop” or not to approach. By disabling the sensor(s) 56, 62 that detect the direction of the caregiver, the device 10 is silenced (both visually and audibly) to the caregiver but is still able to detect the approach of others from different directions.

An unexpected benefit that arises from this configuration is that even though the device is unable to detect the approach of others from the general direction of the caregiver, such is not generally needed. The caregiver acts as a living shield to protect the user from impacts and can verbally ask others who are approaching from the side of the caregiver to keep a safe distance away.

The invention has been shown, described, and illustrated in substantial detail with reference to the presently preferred embodiment. It will be understood by those skilled in this art that other and further changes and modifications may be made without departing from the spirit and scope of the invention which is defined by the claims appended hereto.

What is claimed is:

1. A medical alert device, comprising:
(a) a member, said member including a symbol or written message indicative of an injury or physical infirmity of the type that precludes any level of impact to a person; and
(b) means for attaching said member to a portion of said person.

2. The medical alert device of claim 1, wherein said member includes a size and shape that corresponds with an area of the body of said person.

3. The medical alert device of claim 2 wherein said member includes a sufficiently rigid material that is adapted to distribute a portion of impact energy over a wider surface area of said portion of said person.

4. The medical alert device of claim 2 wherein said member includes a cushioning material, said cushioning material attached to said member and adapted to absorb impact energy.

5. The medical alert device of claim 1 wherein said symbol includes a symbol that is associated with the medical arts.

6. The medical alert device of claim 5 wherein said symbol includes a red cross symbol.

7. The medical alert device of claim 1 wherein said means for attaching includes at least one strap attached at one end thereof to said device and that is adapted to pass around a portion of said person and which includes an opposite end that is adapted to be attached to said device.

8. The medical alert device of claim 1 wherein said means for attaching includes at least pair of straps, each of said pair of straps attached at one end thereof to said device and wherein an opposite end of each of said pair of straps includes means for securing each of said opposite ends together.

9. The medical alert device of claim 1 including a source of illumination attached to said member.

10. The medical alert device of claim 9 wherein said source of illumination includes at least one light emitting diode.

11. The medical alert device of claim 10 wherein said light emitting diode includes a plurality of light emitting diodes.

12. The medical alert device of claim 11 wherein said plurality of light emitting diodes are arranged in a pattern sufficient to provide said written message.

13. The medical alert device of claim 1 wherein said written message includes a warning not to make contact with said person or to approach too close to said person.

14. The medical alert device of claim 1 including a source of visible illumination and means for periodically activating said source of visible illumination.

15. The medical alert device of claim 14 including a sensor, said sensor adapted to detect the approach of another person and to output a signal in response to said detection, said signal sufficient to enable said means for periodically activating said source of visible illumination.

16. The medical alert device of claim 1 including an audible source and means for periodically activating said audible source.

17. The medical alert device of claim 16 including a sensor, said sensor adapted to detect the approach of another person and to output a signal in response to said detection, said signal sufficient to enable said means for periodically activating said audible source.

18. The medical alert device of claim 16 wherein said audible source includes a speaker and a tone that is outputted from said speaker.

19. The medical alert device of claim 16 wherein said audible source includes a speaker and a verbal command that is outputted from said speaker.

20. The medical alert device of claim 19 wherein said verbal command warns said another person to stop approaching closer toward said person.

21. The medical alert device of claim 17 wherein said sensor is adapted to detect the distance that said another person is disposed away from said person and to output a first signal in response to said detection occurring at a first distance from said person and to output a second signal in response to said detection occurring at a second distance from said person.

22. The medical alert device of claim 9 wherein said source of illumination is adapted to emit an illumination in at least two different colors and including means for controlling the color of said source of illumination.

23. The medical alert device of claim 22 wherein said means for controlling the color of said source of illumination includes means for alternating said source of illumination between said at least two different colors.
